(19) United States
(12) Patent Application Publication
(10) Pub. No.: US 2012/0232914 A1
(43) Pub. Date: Sep. 13, 2012

(54) MARKETPLACE FOR MARKET INFORMATION

(75) Inventors: Prasad A. Chodavarapu, Bangalore (IN); Rama Kanneganti, Grosse Point Shores, MI (US); Vikram Duvvoori, Gilroy, CA (US)

(73) Assignee: HCL America Inc., Sunnyvale, CA (US)

(21) Appl. No.: 13/043,958

(22) Filed: Mar. 9, 2011

(51) Int. Cl. G06F 21/00; G06Q 30/00

(52) U.S. Cl. 705/1.1; 726/22

(57) ABSTRACT

Apparatus, systems, and methods may operate to receive raw provider data in machine-readable form, where the raw provider data is associated with and provided by data contributors according to incentives made available to the data contributors. Additional activity may include filtering the raw provider data to provide filtered provider data, verifying that data taken from the filtered provider data meets a predefined level of trustworthiness, transforming at least some of the trustworthy data by formatting the data as is, or in summary analysis form according to one of multiple reporting formats to provide formatted data, and publishing the formatted data to at least one subscriber. Additional apparatus, systems, and methods are disclosed.

### BACKGROUND

In many instances, the marketplace for market information is unduly limited, and highly inefficient. For example, big companies with access to large groups of customers gather information from individuals willing to fill out lengthy surveys. This is often a costly process, and typically does not scale well. In an attempt to garner a larger sample size, these same companies may sometimes install programs on consumer desktop computers, or within network browsers, to glean the information. This method is limited as well, because it is specific to each company's needs and there is only so much that can be usefully obtained without active user participation.

For smaller companies, sufficient quantities of useful information can be even more difficult to obtain. And even though pre-packaged market research can be procured from analysts and research firms, the information provided is often not tailored to the needs of the individual purchaser.

Finally, even though market information is useful for companies that sell or provide products/services, the buyers/users of products/services and other parties, such as government/non-government agencies, may also be interested in this information. Currently, there is no easily accessible and cost-effective mechanism to access market information for these additional interested parties.

### BRIEF DESCRIPTION OF THE DRAWINGS

FIG. 1A is a block diagram illustrating elements of a system that operates according to various embodiments of the invention.

FIGS. 1B-1E are flow diagrams illustrating processes that may operate within various elements of the system shown in FIG. 1A.

FIG. 2 is a flow diagram illustrating methods of creating and operating a marketplace for market information according to various embodiments of the invention.

FIG. 3 is a block diagram of apparatus and systems according to various embodiments of the invention.

FIG. 4 is a block diagram of an article of manufacture, including a specific machine, according to various embodiments of the invention.

### DETAILED DESCRIPTION

In many embodiments, the challenge of creating a more robust marketplace for market information may be addressed by creating an open standards-based platform and services that apply incentives to elicit the provision of data, and verify trustworthiness, to determine that the data supplied is truthful. Put more simply, a marketplace may be created where incentives to deliver trustworthy data are provided. Some incentives can be based on the amount of data provided by a given data contributor with penalties for contributing untruthful data. Data contributors can include consumers (buyers), businesses (sellers as well as buyers), merchants, banks, government and non-government agencies, international bodies such as the United Nations and the World Health Organization, industry consortiums, and hardware devices, such as computers, point of sale (POS) terminals, consumer-owned processing devices, among others. Incentives can be managed according to a multi-tiered structure, so that data contributors providing more information, or information with a higher level of trustworthy content, or both, receive greater benefits. Several examples of these mechanisms will now be given.

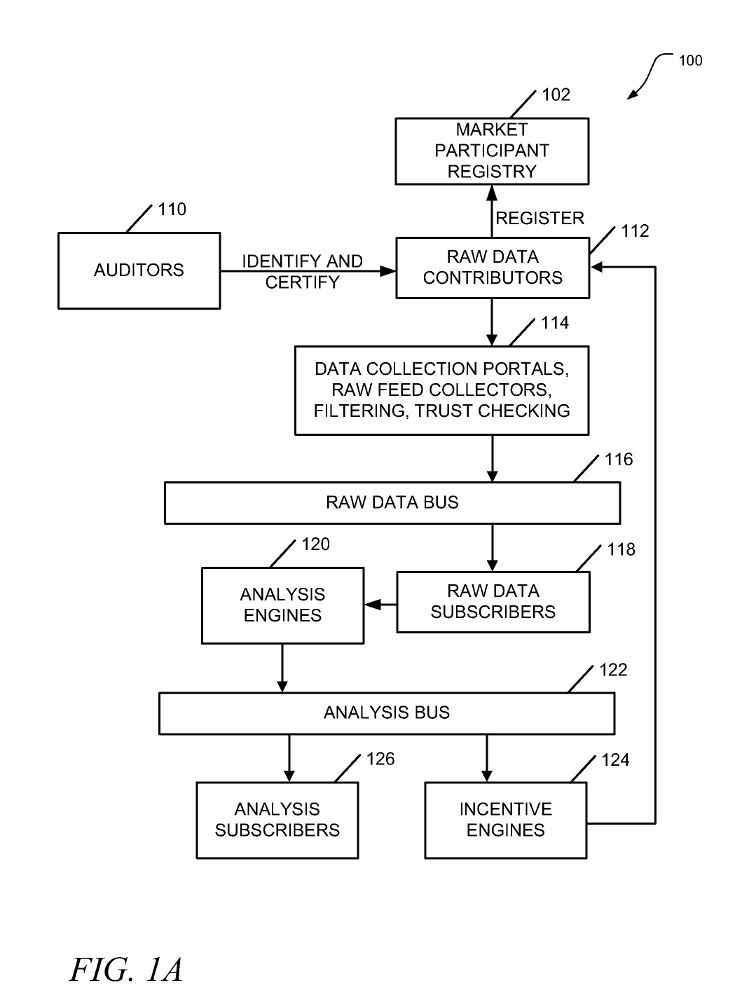

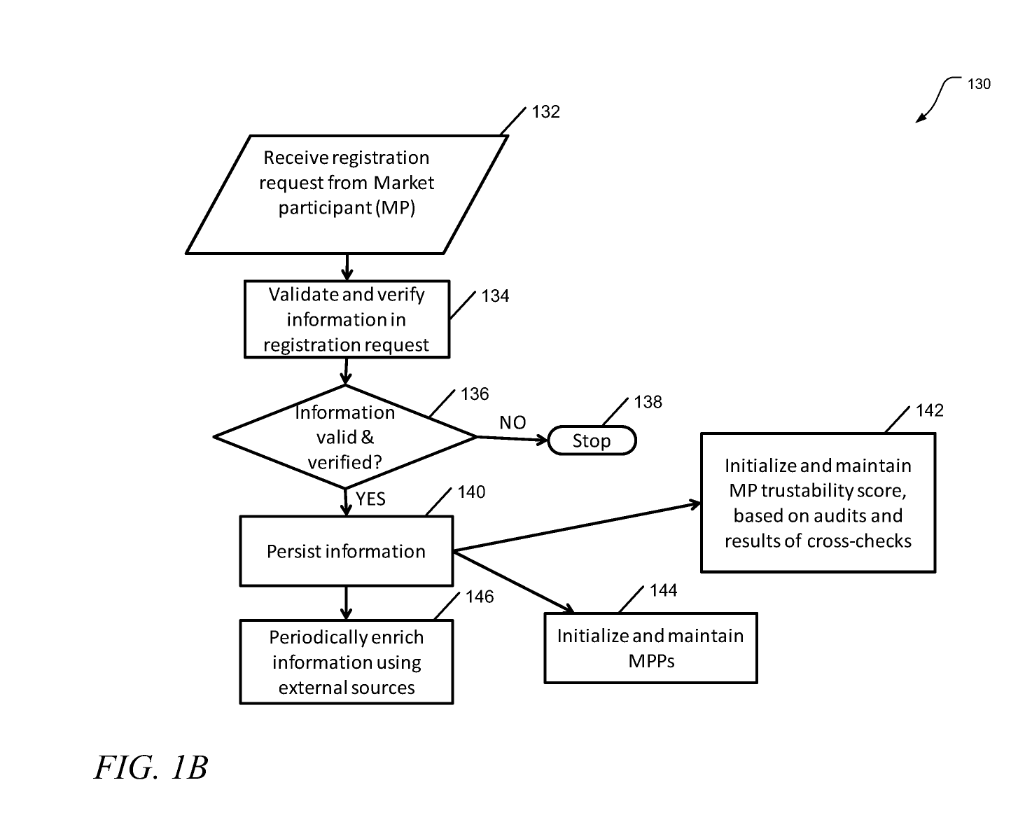

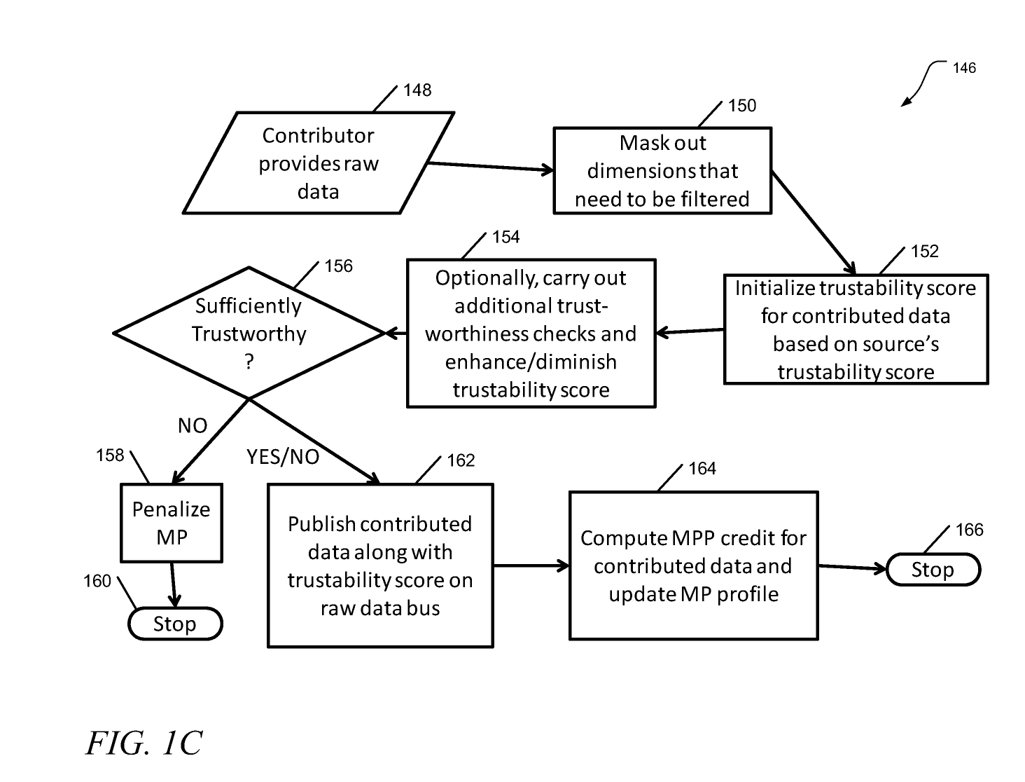

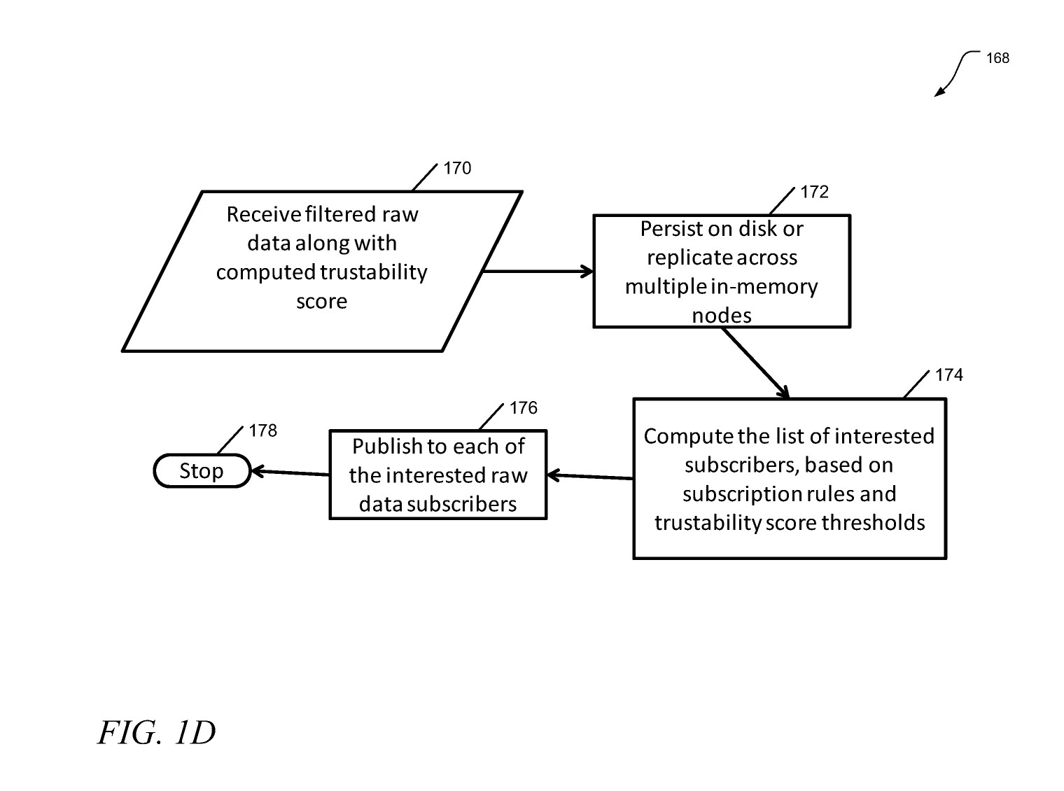

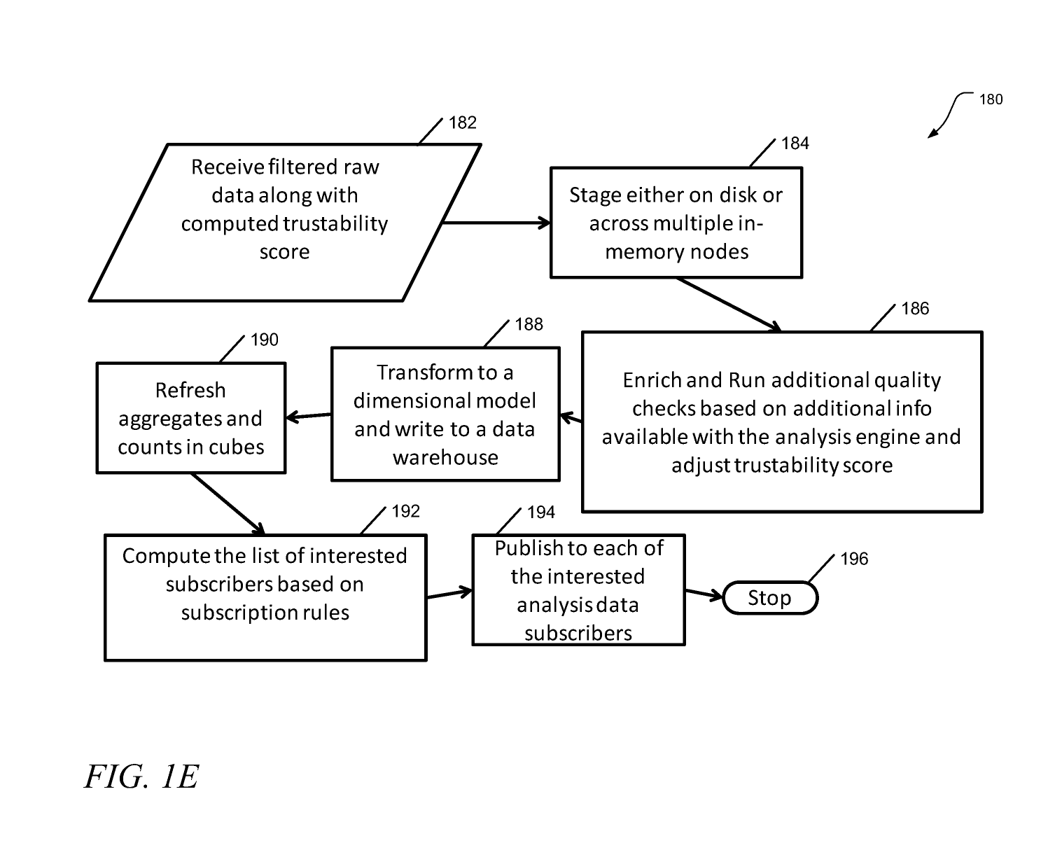

FIG. 1A is a block diagram illustrating elements of a system 100 that operates according to various embodiments of the invention. FIGS. 1B-1E are flow diagrams illustrating processes 130, 146, 168, 180 that may operate within and across various elements of the system shown in FIG. 1A.

Referring now to FIGS. 1A-1E, it can be seen that the system 100, which may be referred to as a marketplace creation system 100, comprises a number of elements, including: auditors 110, raw data contributors 112, and one or more data collection/filtration/checking components 114.

The system 100 may, optionally, require registration of participant profiles, perhaps housing the profile data in a participant registry 102. This data can be used to enrich raw data that is contributed by participants. For example, participant profiles may include location information, gender, age, education, marital status, organizational affiliations for individuals, and turnover/profit/ownership information for organizations. Some of the profile data stored in the registry 102 may be indirectly acquired by accessing public/private databases.

Standardizing structures for raw market data, analysis data and subscription establishment/revocation can facilitate creating an open marketplace for market information. The marketplace may include data contributors (e.g., information sellers) 112, information brokers, and subscribers 126 (e.g., information consumers).

Data contributors 112 may comprise consumers of goods/services which sell or provide information as raw data in return for consideration. The consideration may comprise monetary consideration and/or incentives. Aggregators of information can also contribute raw data. Data contributors 112 may also comprise machines associated with or operated by such consumers or aggregators, such as point of sale terminals, cellular telephones, personal computers, etc. If the raw data is provided in a standard format, it is easier to consume, value, and price. Data auditors 110 may comprise persons or machines to audit the data provided by contributors 112, perhaps providing alarms when discrepancies are detected. Auditors 110 can be used to determine whether data is being published truthfully. Auditing can occur in-line, or as an off-line process.

As part of some embodiments, perhaps prior to the reception or collection of raw data, a registration process 130 may occur (see FIG. 1B). In this case, registration requests are received from market participants (MPs) at block 132. The information in the request can be verified and validated at block 134. If it is determined at block 136 that verification fails (e.g., the information in the request is false) or validation fails (e.g., the information in the request does not meet system requirements), the registration stops at block 138. Otherwise, the registration information is persisted in the system 100 at block 140, and may be used to initialize at block 142 an MP trustability score that is subsequently maintained, perhaps based on audits and cross-checking. Credits, in the form of cash or points, for example, may also be initialized during registration and subsequently, maintained on behalf of the registered MP at block 144. In some cases, the registration information provided on behalf of the registered MP may be periodically enhanced using external sources (e.g., public data sources) at block 146.

The data collection components 114 may include data collection portals and/or raw feed data collectors. These components 114 may take the form of individual, personal computers (e.g., desktop computers, notepads, or cellular telephones), clients, servers, and combinations of similar acquisition elements.

Data filtration components 114 may comprise filters and blocks. Filters can be used to mask out private or confidential data. Such filtering can occur prior to the raw data being received by the marketplace system 100, or after it is received, within the components 114. Filters may also be used to permit the reception of raw data that satisfies certain strictures, such as data that is provided by a specific provider, or an approved list of providers. Some filters might include restraints on the amount of data allowed per unit time, the geographic origin of the data, the data type (financial data vs. customer experience data), or the time of data reception (e.g., data may be received from 8 am until noon, weekdays only). In some cases, data may be blocked entirely (e.g., repeated data, or data from a source having an expired registration).

Trustworthiness checking components 114 can be used to verify the trustworthiness of data. For example, received data may be randomly checked with the alleged contributor, to be sure the received data emanates from the reported source. Received data can also be cross-checked. For example, data received from buyers can be checked against sales data from sellers to determine whether sales reported by buyers actually match purchase data supplied by the respective vendors.

A trustability score may optionally be assigned by the trustworthiness checking components 114 to each data contribution received. The trustability score for each data contribution may be initialized based on the trustability attributes of the source, such as whether independent audits are performed on the source's contributed data, the frequency of such audits, the certification level of the auditor, and the results of past audits. Trustability scores initialized in this manner for each contribution may further be increased/decreased, such as when a cross-check on the specific data contribution succeeds/fails.

In some embodiments, a standard structure for raw data contributions can be provided and used for gathering information. An example of such a structure using eXtensible Markup Language (XML), is shown below:

```
<Purchase Status=”Done”>
  <Date>2010-01-14</Date>
  <Time>16:00:00</Time>
  <Purchaser Type=”Individual” IdStandard=”SSN”>
  <Id>...</Id>
  </Purchaser>
  <Seller Type=”Organization” IdStandard=”DUNS”>
  <Id>...</Id>
  </Seller>
  <Channel Type=”Web”>
  <Address>www.amazon.com</Address>
  </Channel>
  <Item IdStandard=”GTIN”>
  <Id>...</Id>
  </Item>
  <FinancialValue Currency=”USD”>
  <Value>1000.00</Value>
  </FinancialValue>
  <ProofOfPurchase Provider=”Seller”>
  <TransactionId>...</TransactionId>
  </ProofOfPurchase>
</Purchase>
```

Thus, as part of data reception in which the components 114 are active, a data reception process 146 may operate (see FIG. 1C). Here a source of the data provides raw data at block 148. Dimensions to be filtered are masked at block 150, and an initial trustability score may be assigned to the data at block 152. The trustability score may be altered at block 154, using ongoing checks and supplementary information. At block 156, a determination is made as to whether the data is sufficiently trustworthy, based on a threshold set by subscribers and/or the system 100. If the trustability score of the data falls below a minimum acceptable threshold, the MP that supplied the data may be penalized, perhaps by deducting a fixed number of points that have been previously credited, or a variable number of points based on the level of trustability that has been attained.

If the trustability score is sufficient, as determined at block 156, then the data can be published to the data bus 116. The trustability score of the data may be published to the bus 116 as well. Once the data is accepted for publication, credit may be awarded to the MP that supplied the data, perhaps in the form of marketplace participation points (MPPs). This credit is calculated at block 164, and the MP profile in the registry 102 is updated accordingly. The reception process may end at block 166.

The received data can be provided to a raw data bus 116. Raw data subscribers 118 may receive the raw data (sans analysis) from the bus 116. As part of the bus operational process 168, reception, persistence, computation/transformation, and publication activities may occur. Thus, filtered raw data and calculated trustability scores may be received on the bus 116 at block 170. The data and trustability scores can be persisted at block 172 in non-volatile storage and/or replicated across the system 100 in memory housed in a variety of nodes.

In many embodiments, a standard, cost effective mechanism can be provided to subscribers, such as companies/individuals interested in market information, so that the information they seek is readily available, with verifiable quality (based on trustworthiness). The subscribers 118 having an interest in the filtered raw data can be determined at block 174, perhaps based on a set of subscription rules and trustability score thresholds. At block 176, portions of the filtered raw data are published to individual subscribers 118 and groups of subscribers 118 that are determined to have an interest in the data. The bus operational process may end at block 178.

Information brokers can analyze the data provided by the raw data bus 116 and provide processed data to processed data subscribers 126. The processing of the raw filtered data may include real time aggregation from multiple data contributors and/or transformation by analysis engines 120, such as by the application of analytical models and mining for patterns. Information brokers may comprise machines (e.g., the analysis engines 120) used to process the data, transforming it from one state into another, and to provide analysis of the data (after filtration and/or verification by the components 114), or of the transformed data.

The analysis engines 120 may operate according to an analysis process 180. Thus, the analysis engines 120 may operate to receive filtered raw data at block 182, along with corresponding trustability scores. The data and scores can be staged at block 184 in non-volatile storage and/or replicated across the system 100 in memory housed in a variety of nodes.

At block 186, trustability scores can be further adjusted, perhaps based on additional data available with the analysis engines 120, or more rigorous standards imposed at this point in the process. The data can be processed according to various analysis techniques, and transformed to a dimensional model prior to storage in a data warehouse at block 188.

Aggregates and counts of the data, scores, and results sets (e.g., one or more structured query language (SQL) result sets that each comprise a set of rows from a database, as well as meta-information about the query, such as the column names, and the types and sizes, etc.) can be refreshed at block 190. The data, scores, aggregates, and counts, as well as result sets, may be maintained in multidimensional data cubes.

The subscribers 126 having an interest in the results of data analysis can be determined at block 192, perhaps based on a set of subscription rules and trustability score thresholds. At block 194, portions of the analysis results are published to individual subscribers 126 and groups of subscribers 126 that are determined to have an interest in the data. The analysis process may end at block 196.

Subscribers 118, 126 can be purchasers of formatted data, raw filtered data, and analysis data. Thus, subscribers may comprise merchants, strategy companies, individual consumers, etc. Subscribers 118, 126 may also comprise machines that consume the data.

A standard subscription mechanism can be offered in some embodiments so that processed data is available in real-time or near real-time. For example, a marketplace data feed can be provided to subscribers 118, 126, perhaps provided by an analysis bus 122.

Incentives can be provided to contributors 112 by incentive engines 124. In some embodiments, the incentives may simply be access to analyzed data; the level of access for each raw data contributor 112 being proportional to the amount of raw data contributed. In other words, many raw data providers may contribute raw data in return for the aggregation and analysis of aggregated data.

An incentive structure for participants in the marketplace can also be established. Some incentive structures are tiered, to provide added incentives for active participation, and reduced incentives for limited participation.

In embodiments that deal with transactions (purchases/sales) having a financial value (cost/price), every transaction reported may earn MPPs proportional to the value of the transaction. MPPs accumulated by each participant can be used to purchase subscriptions or queries of analyzed market data. Each subscription or query may expend a number of MPPs proportional to the average transaction value in the returned analysis data set, for example. Users may be provided as a joining bonus a fixed number of points or allowed an absolute or percentage margin on MPPs to enable making an initial set of queries.

In embodiments that do not deal with transactions that naturally possess a financial value (e.g., illness symptom data), each contribution may earn a fixed number of MPPs, and each query may expend a fixed number of MPPs.

MPPs may be purchased in return for hard currency, or exchanged. For example, MPPs may be exchanged for discounts offered by merchants, loyalty points issued by entities such as airlines and hotel chains, and any virtual currency issued by online entities. Market participants with a large accumulation of MPPs may be rewarded with special awards or honor list memberships. Thus, many embodiments may be realized.

For example, some embodiments may emphasize buy-side collaboration. In this case, buyers can contribute sanitized but trustworthy raw data regarding prospective or completed purchases in return for the ability to query and analyze the existing demand for the goods and services they procure, along with the current price levels.

In some embodiments, organizations looking to hire personnel can serve as data contributors, providing sanitized but trustworthy raw data on the specific skills and experience they seek in prospective employees, or that they have obtained through recent hires, along with the number of positions in each geographic area, and salary ranges. In return, the same organization, as a subscriber, can obtain an analysis of the total demand for such talent in the areas where it operates, along with the salaries offered by others for similar skills and experience. Incentives and/or filters may include publishing data to a subscriber for only those geographic regions where data has been supplied by that subscriber (as a data contributor).

In another example, individuals can contribute data (manually or automatically, perhaps via radio frequency identification device checkout data, credit cards, smart cards, or credit card billing statements) for each of their purchases made within a selected time period (e.g., one month). In return, they may be offered incentives that include reward credit points or memberships to clubs that pool frequent purchasers of an item and negotiate bulk discounts. For example, frequent business travelers to a city can be offered membership to a virtual club that will negotiate a bulk discount on room rates in the top three most popular business hotels, as ranked on a selected travel web site (e.g., www.tripadvisor.com).

In a further example, product/service feedback data may be contributed by buyers and in return, the contributors (as subscribers) may receive aggregated data on similar/dissimilar experiences. Independent entities may operate as brokers (e.g., stock market analysts), collecting customer satisfaction data and transforming the raw data to provide an analysis that includes published advisories on product/service performance.

Some embodiments emphasize sell-side collaboration. In this case, sellers can contribute sanitized data (selectively based on what they are willing to share) on their current inventory levels and current sales transactions in return for receiving analysis data on overall inventory levels, sales volumes, and prices within their industry.

For example, hotels, parking providers, fuel pumps, coaches/trainers, schools and other goods/service providers can operate as subscribers to gauge product/service demand and vary their pricing using the data provided to them via subscription. In return, the data they provide as contributors would not be so specific that competitors would be enabled to target and harm them.

In another example, vendors to businesses may operate as data contributors to share the payment history of customers, sanitized to comply with contractual conditions that may be in place. In return, they can obtain aggregated, formatted data as subscribers to determine the speed at which businesses in various segments (e.g., geographic, size, industry) pay their suppliers.

In some cases, citizens can cooperate with government or watchdog agencies. For example, citizens can contribute sanitized observations as raw data (that protects the privacy of the contributor) to allow a government agency (e.g., the World Health Organization) to detect overall trends in health for specific diseases, such as obesity, and to take corrective measures in response.

In another example, if citizens contribute data on illness symptoms they experience, government health ministries and others can detect and track the spread of epidemics. In return for providing this information, contributors may be notified of epidemic outbreaks and precautions, and/or provided free treatment.

In another example, citizens as well as whistleblowers can contribute data on observed corruption within government departments. In return, watchdog organizations that collect and aggregate corruption reports may be able to lobby through the media to reduce corruption in a particular department. Therefore, many embodiments may be realized.

Thus, some embodiments of the invention can operate to:
Contribute raw market data in standard forms that are machine-readable.
Sanitize raw market data before contribution, based on the contributor's expressed sensitivities and government/industry regulations.
Assess and increase trustworthiness of contributed raw market data.
Provide subscriptions to selected subsets of raw market data.
Provide subscriptions to specific aggregates, trend alerts, and other analyses for specific market subsets.
Answer queries about demand/price/other information in a specific market such as market for a specific product or service (e.g., some embodiments may operate to provide query services for a specified market and a product or service).
Manage incentive schemes for market data contributors.

Some embodiments of the invention operate using market data in standard formats, which can be provided to the components 114. These formats may be provided for planned purchases, inventory reports, sales that have been made, health observations, and customer feedback, among others. The identifiers used in these common formats may be taken from commonly accepted identifier schemes. For example, identifiers for products/services and associated dimension names and values include, among others: GTIN (Global Trade Item Number) for products, D&B (Dun & Bradstreet) number for organizations, SKU (Stock Keeping Unit) numbers, and ISO codes (e.g., for languages, countries, currency, etc.).

Raw market data can be sanitized prior to accepting its contribution, perhaps according to contributor sensitivities and government/industry regulations. Thus, contributors may opt-out of contributing dimension values they do not want to share. Applicable regulations may be imposed to conform contributed data to what is permitted by law.

As noted previously, the trustworthiness of contributed raw data may be increased by using registration agreements to bind contributors to providing truthful data, to the best of their knowledge and/or capability. Auditing agencies may operate to certify their customers as providers of trustworthy information. Auditors can provide certificates to show that a particular source of data is trustworthy.

The trustworthiness of contributed data may be assessed and enhanced using consistency checks, perhaps via market-specific tools. Cross-checking between buyer and seller contributions may form part of the process. Abnormal trends in contributed raw market data may be automatically detected and investigated, perhaps when preselected thresholds are crossed.

Participants who contribute data that fails trustworthiness checks may be penalized by deductions to their accumulated MPP value and/or temporary/permanent suspensions from the marketplace for market information.

Interested parties can subscribe to data feeds, based on a variety of criteria. These criteria include contributor meta-data, such as geography, demography, language, etc., as well as selected dimensions in the raw data feed (e.g., product codes).

Interested parties can also take advantage of a variety of criteria to tailor subscriptions to aggregates, trend analyses/alerts, and other services, based on a variety of criteria. Such criteria may include selecting dimensions in the aggregate/analysis data feed, providing thresholds for aggregates, and/or selecting one or more specific analysis providers, among others.

Analysis data provided to interested parties may be filtered, based on subscriber preferences, to include only data contributed by audited participants or data that passes one or more trustworthiness tests and/or attains a trustability score greater than a set threshold.

Incentives may be fixed or proportional. In proportional schemes, the amount of data contributed and the dimensions revealed can be used to determine the amount of aggregate/analysis information subscribers receive. For example, a contributor may also be a subscriber that receives data, with analysis, based on the amount and/or quality of the data they have contributed. The amount of information received can thus be proportional to what is contributed, or fixed.

Thus, many embodiments of the invention may be realized, and each can be implemented in a variety of architectural platforms, along with various operating and server systems, devices, and applications. Any particular architectural layout or implementation presented herein is therefore provided for purposes of illustration and comprehension only, and is not intended to limit the various embodiments.

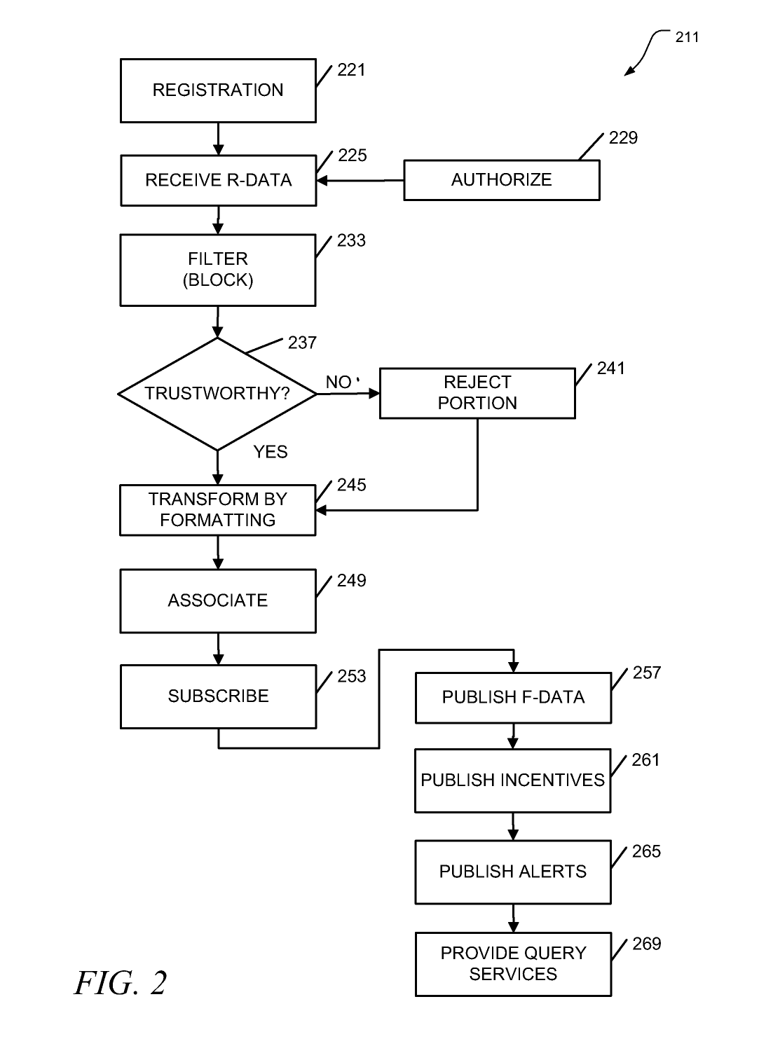

For example, FIG. 2 is a flow diagram illustrating methods 211 of creating and operating a marketplace for market information according to various embodiments of the invention. The methods 211 are implemented in a machine-accessible and readable medium, and are operational over processes within and among networks. The networks may be wired, wireless, or a combination of wired and wireless. The methods 211 may be implemented as instructions which, when accessed by a specific machine, perform the processing depicted in FIG. 2.

In some embodiments, information vendors can register and advertise what they are selling (e.g., type of data, and/or type of analysis). Buyers can register and advertise the type of information they desire to receive, and how it should be formatted. Information brokers, perhaps providing analysis services, can also advertise.

Thus, in some embodiments, a processor-implemented method 211 that can be executed on one or more processors that perform the method may begin at block 221 with registering data contributors, subscribers, and/or brokers, wherein the registering includes receiving information to indicate the type of raw provider data to the contributed/analyzed, or the type of formatted data to be published.

The method 211 may go on to block 225 to include receiving the raw provider data in machine-readable form, wherein the raw provider data is associated with and provided by data contributors according to incentives provided to the data contributors.

The raw provider data may include consumption data, such as past purchases, present purchases, and future planned purchases; or product/service experience data, such as treatment by vendors, reliability of products, comparative value, etc. Thus, in many embodiments, the raw provider data comprises one of consumption data or experience data.

The raw provider data may comprise demographic (purchaser age, purchaser gender, etc.), geographic (point of sale location, purchaser residence location, etc.), and purchase information (vendor name, vendor type, item name, item type, item brand, item price, discount, item quantity, purchase date, purchase experience, etc.), among other types of information. Thus, in some embodiments, the raw provider data comprises substantially real-time purchase data transmitted from one of a point of sale terminal or an online retailer, including at least one of purchaser geographic information, purchaser demographic information, or purchased item information.

The receipt of the raw provider data may be conditioned on consent provided by the data contributor. Thus, the method 211 may include, at block 229, receiving an indication of authorization by at least one of the data contributors to permit receiving the raw provider data.

The method 211 may continue on to block 233, with filtering the raw provider data to provide filtered provider data.

Data contributors, such as consumers, may designate certain information that is not to be shared, which guides filtering algorithms. Thus, the activity at block 233 may comprise filtering according to dimension values that have been designated as not to be shared.

Legal constraints may be imposed on received data, so that only lawful data is available for further processing. Thus, the activity at block 233 may comprise filtering according to regulations imposed by at least one governmental agency.

If a contributor of data is found to provide untrustworthy data, that source can be blocked from providing data in the future. Thus, the activity at block 233 may comprise preventing further reception of the raw provider data provided by a source associated with a portion of the filtered provider data that does not meet a predefined level of trustworthiness.

Filtration of the raw provider data can occur in accordance with the role of the data contributor (e.g., a consumer filtering billing address information, or a bank filtering customer account numbers and names). Thus, the activity at block 233 may comprise filtering based on a role associated with at least one of the data contributors.

The method 211 may continue on to block 237 with verifying that trustworthy data taken from the filtered provider data meets a predefined level of trustworthiness. Verification of data trustworthiness may include consistency checking within the data (e.g., between data elements in a set), cross-checking the data (e.g., comparing provider data with vendor data), and abnormal trend detection (e.g., noting abnormally large quantities of expensive items purchased by a low-income population, or increasing numbers of items purchased from vendors that are not approved to sell them). Thus, the activity at block 237 may comprise at least one of consistency checking, cross-checking between buyer and seller, or abnormal trend detection. If it is determined that some part of the data does not meet the predefined level of trustworthiness, some or all of the data provided in the same batch, or by the same provider, may be rejected, at block 241.

The method 211 may continue on to block 245 with transforming at least some of the trustworthy data by formatting the trustworthy data according to one of multiple reporting formats to provide formatted data.

Available reporting formats may vary widely, including the selection of dimensions, thresholds, and analyses providers, among others. Thus, the reporting formats may comprise selected dimensions in the filtered provider data, selected thresholds for aggregates in the filtered provider data, or a selected analysis provider, among others.

Elements of the trustworthy data (e.g., purchased items in the data stream) may be associated with industry-standard designations, such as generic part numbers. Thus, the method 211 may continue on to block 249 with associating elements of the trustworthy data with industry standard reference designation information.

The formatted data can be provided as part of a paid subscription. Thus, the method 211 may continue on to block 253 with subscribing to a subscription service to receive the formatted data on a periodic basis in return for paying a subscription fee. Subscribers to the reports may be selected from among those that provide the raw provider data (e.g., the data contributors). Subscription fees may take the form of cash or credit, perhaps in the form of credit derived from contributing certain quantities of information to the marketplace.

The method 211 may continue on to block 257 with publishing the formatted data to at least one subscriber. Publication can take many forms, including storage in a persistent medium, hardcopy printing, and using a visible electronic display.

Part of the publication activity can include the publication of formatted data in near real-time, with a selectable delay in publication that varies with a payment schedule, The subscriber payment may comprise actual currency, reward credit points, some amount of raw provider data credit that has been provided by the subscriber, or an affiliate, or a combination of these. Thus, the activity at block 257 may comprise publishing the formatted data to at least one subscriber according to a timed publication schedule.

As noted previously, incentives may be structured in a number of ways. For example, the incentives may be based on quantity and/or quality of data. Incentives may also be time-based, to supply specific, requested needs by subscribers in a timely fashion. The incentives, and incentive structures, provided to contributors may be made public (as to the general public, subscribers, and/or other contributors), or kept private (so that only the contributor knows what incentives are being provided). Thus, in some embodiments, the method 211 may continue on to block 261 with publishing the incentives in human-readable form to at least one subscriber. The activity at block 261 may also include publishing an incentive structure to the data contributors.

Recipients of the reports can be alerted if certain parameters are exceeded, perhaps prompting them to promote sales on certain items to increase spending with respect to designated item types, for example. Thus, the method 211 may continue on to block 265 with publishing alerts to one or more subscribers when some elements of the trustworthy data, or statistics associated with the data, exceed predefined thresholds.

Queries about demand, price, and/or other information may be received from subscribers. These queries may be made regarding a specific market, such as market for a specific product or service. Query services may be provided to respond to such queries. Thus, the method 211 may continue on to block 269 with providing query services for a specified market and a product or service.

The methods described herein do not have to be executed in the order described, or in any particular order. Moreover, various activities described with respect to the methods identified herein can be executed in repetitive, serial, or parallel fashion. The individual activities of the system 100 and methods 211 shown in FIGS. 1 and 2, respectively, can also be combined with each other and/or substituted, one for another, in various ways. Information, including parameters, commands, operands, and other data, can be sent and received in the form of one or more carrier waves. Thus, many other embodiments may be realized.

The methods of creating a marketplace for market information shown in FIG. 2 can be implemented in various devices, as well as in a computer-readable storage medium, where the methods are executed by one or more processors. Further details of such embodiments will now be described.

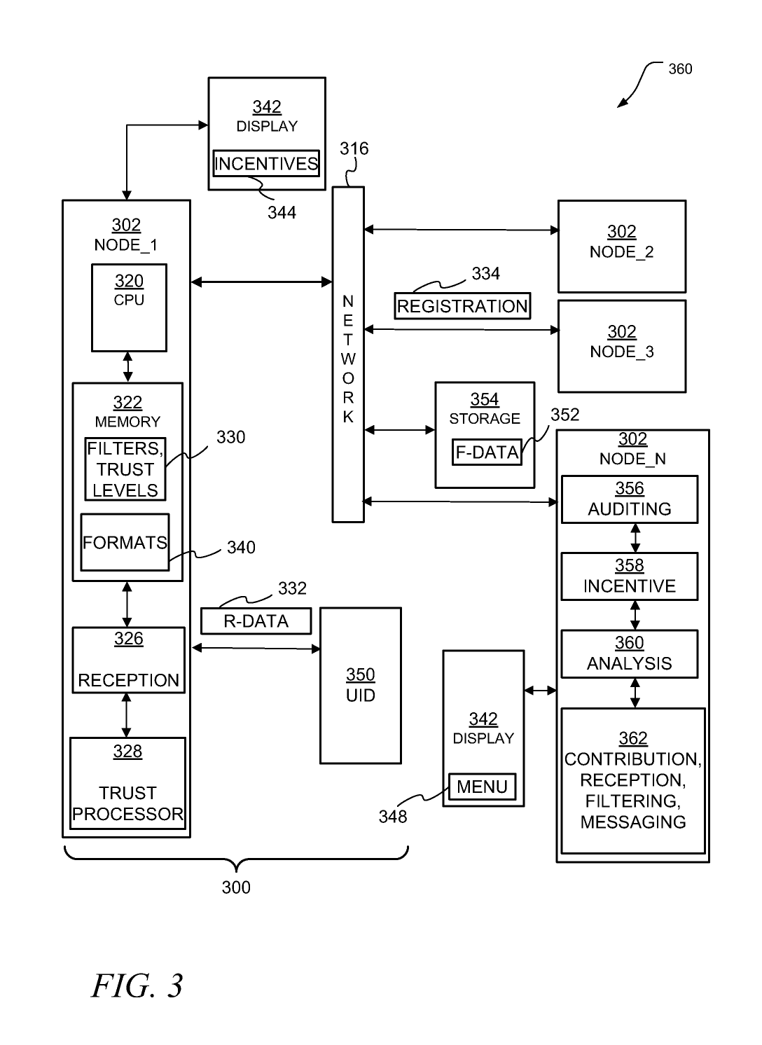

FIG. 3 is a block diagram of apparatus 300 and systems 360 according to various embodiments of the invention. Here it can be seen that an apparatus 300 used to create and operate a marketplace for market information may comprise one or more processing nodes 302, one or more processors 320, memory 322, a reception module 326, a trust processor 328, filters (e.g., to establish levels of trustworthiness) 330, and one or more displays 342. The apparatus 300 may comprise a server, a client, or some other networked processing node.

The processing nodes 302 may comprise physical machines or virtual machines, or a mixture of both. The nodes 302 may also comprise networked entities, such as servers and/or clients. In some basic implementations, the operations described can occur entirely within a single node 302.

In some embodiments then, an apparatus 300 may comprise a node 302 (e.g., NODE_1) including a reception module 326 to receive raw provider data 332 in machine-readable form, the raw provider data 332 associated with and provided by data contributors according to incentives provided to the data contributors. The apparatus 300 may further comprise a trust processor 328 included in the node to filter the raw provider data 332 to provide filtered provider data. The processor 328 may also operate to verify that trustworthy data taken from the filtered provider data meets a predefined level of trustworthiness, to transform at least some of the trustworthy data by formatting the trustworthy data according to at least one of multiple reporting formats to provide formatted data 352, and to publish the formatted data 352 to at least one subscriber. The apparatus 300 to create and operate a marketplace for provider data may comprise a desktop computer, workstation, or server.

An incentive module, located locally or remotely, can be used to provide incentives to data contributors. Thus, in some embodiments, the apparatus 300 comprises an incentive module 358 to manage the incentives 344 provided to data contributors according to a tiered structure.

An auditing module can be used to provide vendor purchase data, or other verification data, that can be used to verify the correctness of the raw provider data 332. Thus, the apparatus 300 may comprise an auditing module 356 to provide verification data to the trust processor 328.

Subscribers may subscribe to raw data, without analysis (e.g., analytic firms). Subscribers may also subscribe to processed data (e.g., data consumers that purchase pre-processed data, perhaps in real time. An analysis processor can be used to aggregate, correlate, detect trends, etc. Thus, the apparatus 300 may comprise an analysis module 360 to receive and process at least some of the trustworthy data to provide at least some of the formatted data 352 as processed data. The formatted data 352 may be formatted according to a variety of formats 340. Still further embodiments may be realized.

For example, it can be seen that a system 360 that operates to implement an incentive-driven marketplace for information may comprise multiple instances of the apparatus 300. The system 360 might also comprise a cluster of nodes 302, including physical and virtual nodes. It should be noted that any of the nodes 302 may include any one or more of the elements explicitly shown in nodes NODE_1, NODE_N. It should also be noted that the apparatus 300 and system 360 may be similar to or identical to the system 100, respectively, of FIG. 1.

The nodes 302 may exist as a device embedded within another structure (e.g., as an embedded device), or as a regular desktop or laptop computer that includes a display 342 to show the activities conducted while the node 302 is active. Thus, the system 360 may also comprise a display 342 coupled to the nodes 302 to display visible indications of the activities conducted at the nodes 302.

A system 360 may include several nodes to divide up the processing tasks. Thus, in some embodiments, a system 360 can operate using multiple nodes: one node (e.g., NODE_1) to receive data 332, and another node (e.g., NODE_N) to manage incentives 344.

In some embodiments then, a system 360 comprises at least one first node (e.g., NODE_1) including a reception module 326 to receive raw provider data 332 in machine-readable form, the raw provider data 332 associated with and provided by data contributors (e.g., the user input device 350, which may also comprise a node 302) according to incentives provided to the data contributors. The system 360 may further comprise at least one second node (e.g., NODE_2) including a trust processor 328 to filter the raw provider data 332 to provide filtered provider data, to verify that trustworthy data taken from the filtered provider data meets a predefined level of trustworthiness, to transform at least some of the trustworthy data by formatting the trustworthy data according to at least one of multiple reporting formats to provide formatted data 352, and to publish the formatted data 352 to at least one subscriber.

Other nodes may be used to further partition processing, logically or physically, according to data contribution (e.g., consumer devices, banks, merchants), data reception, filtering, analysis, incentive handling, messaging (to communicate raw or processed data to subscribers), and trustworthiness checking. Nodes can also be used to store templates associated with multiple predefined reporting formats 340. Thus, the system 360 may comprise at least one third node (e.g., NODE_3) coupled to the first and/or second nodes, the third node to host at least one of a data contribution module 362, a data reception module 326, a filtering module 362, an analysis module 360, an incentive module 358, or a messaging module 362.

A display can be used to select reporting formats. There are at least two types of formats that can be applied to the formatted data 352: machine compatible formats, and human-readable formats. Thus, the system 360 may comprise one or more displays 342 operatively coupled to one or more nodes 302, the display(s) 342 to display a menu 348 offering a choice of the multiple reporting formats 340.

The apparatus 300 and system 360 may be implemented in a machine-accessible and readable medium that is operational over one or more networks 316. The networks 316 may be wired, wireless, or a combination of wired and wireless. The apparatus 300 and system 360 can be used to implement, among other things, the processing associated with the system 100 of FIG. 1, and the methods 211 of FIG. 2. Modules may comprise hardware, software, and firmware, or any combination of these. Additional embodiments may be realized.

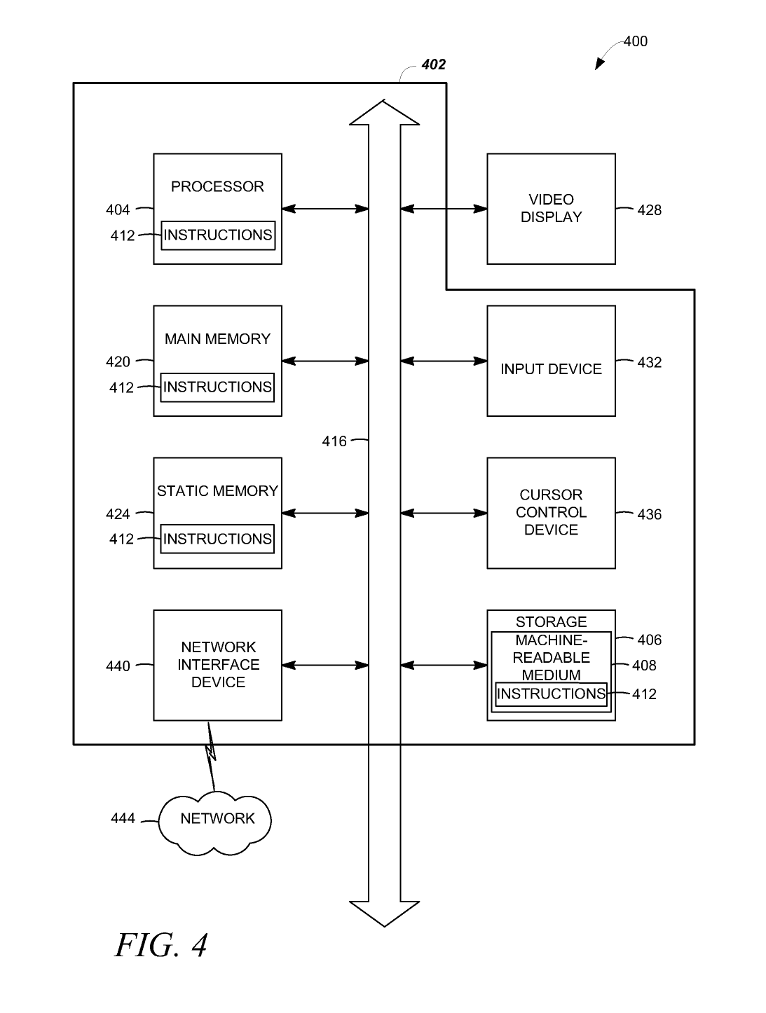

For example, FIG. 4 is a block diagram of an article 400 of manufacture, including a specific machine 402, according to various embodiments of the invention. Upon reading and comprehending the content of this disclosure, one of ordinary skill in the art will understand the manner in which a software program can be launched from a computer-readable medium in a computer-based system to execute the functions defined in the software program.

One of ordinary skill in the art will further understand the various programming languages that may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembly or C. The software components may communicate using any of a number of mechanisms well known to those of ordinary skill in the art, such as application program interfaces or interprocess communication techniques, including remote procedure calls. The teachings of various embodiments are not limited to any particular programming language or environment. Thus, other embodiments may be realized.

For example, an article 400 of manufacture, such as a computer, a memory system, a magnetic or optical disk, some other storage device, and/or any type of electronic device or system may include one or more processors 404 coupled to a machine-readable medium 408 such as a memory (e.g., removable storage media, as well as any memory including an electrical, optical, or electromagnetic conductor) having instructions 412 stored thereon (e.g., computer program instructions), which when executed by the one or more processors 404 result in the machine 402 performing any of the actions described with respect to the systems and methods above.

The machine 402 may take the form of a specific computer system having a processor 404 coupled to a number of components directly, and/or using a bus 416. Thus, the machine 402 may be similar to or identical to the system 100 of FIG. 1, or the apparatus 300 or system 360 shown in FIG. 3.

Turning now to FIG. 4, it can be seen that the components of the machine 402 may include main memory 420, static or non-volatile memory 424, and mass storage 406. Other components coupled to the processor 404 may include an input device 432, such as a keyboard, or a cursor control device 436, such as a mouse. An output device 428, such as a video display, may be located apart from the machine 402 (as shown), or made as an integral part of the machine 402.

A network interface device 440 to couple the processor 404 and other components to a network 444 may also be coupled to the bus 416. The instructions 412 may be transmitted or received over the network 444 via the network interface device 440 utilizing any one of a number of well-known transfer protocols (e.g., HyperText Transfer Protocol). Any of these elements coupled to the bus 416 may be absent, present singly, or present in plural numbers, depending on the specific embodiment to be realized.

The processor 404, the memories 420, 424, and the storage device 406 may each include instructions 412 which, when executed, cause the machine 402 to perform any one or more of the methods described herein. In some embodiments, the machine 402 operates as a standalone device or may be connected (e.g., networked) to other machines. In a networked environment, the machine 402 may operate in the capacity of a server or a client machine in server-client network environment, or as a peer machine in a peer-to-peer (or distributed) network environment.

The machine 402 may comprise a personal computer (PC), a tablet PC, a set-top box (STB), a PDA, a cellular telephone, a web appliance, a network router, switch or bridge, server, client, or any specific machine capable of executing a set of instructions (sequential or otherwise) that direct actions to be taken by that machine to implement the methods and functions described herein. Further, while only a single machine 402 is illustrated, the term “machine” shall also be taken to include any collection of machines that individually or jointly execute a set (or multiple sets) of instructions to perform any one or more of the methodologies discussed herein.

While the machine-readable medium 408 is shown as a single medium, the term “machine-readable medium” should be taken to include a single medium or multiple media (e.g., a centralized or distributed database, and/or associated caches and servers, and or a variety of storage media, such as the registers of the processor 404, memories 420, 424, and the storage device 406 that store the one or more sets of instructions 412. The term “machine-readable medium” shall also be taken to include any medium that is capable of storing, encoding or carrying a set of instructions for execution by the machine and that cause the machine 402 to perform any one or more of the methodologies of the present invention, or that is capable of storing, encoding or carrying data structures utilized by or associated with such a set of instructions. The terms “machine-readable medium” or “computer-readable medium” shall accordingly be taken to include tangible media, such as solid-state memories and optical and magnetic media.

Various embodiments may be implemented as a stand-alone application (e.g., without any network capabilities), a client-server application or a peer-to-peer (or distributed) application. Embodiments may also, for example, be deployed by Software-as-a-Service (SaaS), an Application Service Provider (ASP), or utility computing providers, in addition to being sold or licensed via traditional channels.

Implementing the apparatus, systems, and methods described herein may operate to create a marketplace for market information, where commoditized data is provided according to incentives, and verified to be trustworthy prior to processing and distribution. Increased sales efficiency between buyers and sellers, more immediate response to customer purchasing issues, and increased user satisfaction may result.

This Detailed Description is illustrative, and not restrictive. Many other embodiments will be apparent to those of ordinary skill in the art upon reviewing this disclosure. The scope of embodiments should therefore be determined with reference to the appended claims, along with the full scope of equivalents to which such claims are entitled.

The Abstract of the Disclosure is provided to comply with 37 C.F.R. §1.72(b) and will allow the reader to quickly ascertain the nature of the technical disclosure. It is submitted with the understanding that it will not be used to interpret or limit the scope or meaning of the claims.

In this Detailed Description of various embodiments, a number of features are grouped together in a single embodiment for the purpose of streamlining the disclosure. This method of disclosure is not to be interpreted as an implication that the claimed embodiments have more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. An apparatus, comprising:
a node including a reception module to receive raw provider data in machine-readable form, the raw provider data associated with and provided by data contributors according to incentives provided to the data contributors; and
a trust processor included in the node to filter the raw provider data to provide filtered provider data, to verify that trustworthy data taken from the filtered provider data meets a predefined level of trustworthiness, to transform at least some of the trustworthy data according to at least one of multiple reporting formats to provide formatted data, and to publish the formatted data to at least one subscriber.

2. The apparatus of claim 1, further comprising:
an incentive module to manage the incentives provided to the data contributors according to a tiered structure.

3. The apparatus of claim 1, further comprising:
an auditing module to provide verification data to the trust processor.

4. The apparatus of claim 1, further comprising:
an analysis module to receive and process at least some of the trustworthy data to provide at least some of the formatted data as processed data.

5. A system, comprising:
at least one first node including a reception module to receive raw provider data in machine-readable form, the raw provider data associated with and provided by data contributors according to incentives provided to the data contributors; and
at least one second node including a trust processor to filter the raw provider data to provide filtered provider data, to verify that trustworthy data taken from the filtered provider data meets a predefined level of trustworthiness, to transform at least some of the trustworthy data according to at least one of multiple reporting formats to provide formatted data, and to publish the formatted data to at least one subscriber.

6. The system of claim 5, further comprising:
at least one third node coupled to the at least one first node or the at least one second node, the at least one third node to host at least one of a data contribution module, a data reception module, a filtering module, an analysis module, an incentive module, or a messaging module.

7. The system of claim 5, further comprising:
a display operatively coupled to the second node, the display to display a menu offering a choice of the multiple reporting formats.

8. A processor-implemented method to execute on one or more processors that perform the method, comprising:
receiving raw provider data in machine-readable form, the raw provider data associated with and provided by data contributors according to incentives provided to the data contributors;
filtering the raw provider data to provide filtered provider data;
verifying that trustworthy data taken from the filtered provider data meets a predefined level of trustworthiness;
transforming at least some of the trustworthy data according to one of multiple reporting formats to provide formatted data; and
publishing the formatted data to at least one subscriber.

9. The method of claim 8, further comprising:
publishing the incentives in human-readable form to the at least one subscriber.

10. The method of claim 8, wherein the raw provider data comprises one of consumption data or experience data.

11. The method of claim 8, further comprising:
subscribing to a subscription service to receive the formatted data on a periodic basis in return for paying a subscription fee.

12. The method of claim 8, wherein the raw provider data comprises substantially real-time purchase data transmitted from one of a point of sale terminal or an online retailer, including:
at least one of purchaser geographic information, purchaser demographic information, or purchased item information.

13. The method of claim 8, further comprising:
receiving an indication of authorization by at least one of the data contributors to permit the receiving.

14. The method of claim 8, wherein the verifying further comprises:
at least one of consistency checking, cross-checking between buyer and seller, or abnormal trend detection.

15. The method of claim 8, wherein the filtering further comprises:
filtering according to dimension values that have been designated as not to be shared.

16. The method of claim 8, wherein the filtering further comprises:
filtering according to regulations imposed by at least one governmental agency.

17. The method of claim 8, wherein the reporting formats comprise:
selected dimensions in the filtered provider data, selected thresholds for aggregates in the filtered provider data, or a selected analysis provider.

18. The method of claim 8, wherein the at least one subscriber is selected from the data contributors.

19. The method of claim 8, further comprising:
associating elements of the trustworthy data with industry standard reference designation information.

20. The method of claim 8, further comprising:
publishing alerts to the at least one subscriber when some elements of the trustworthy data exceed predefined thresholds.

21. The method of claim 8, further comprising:
preventing further reception of the raw provider data provided by a source associated with a portion of the filtered provider data that does not meet the predefined level of trustworthiness.

22. The method of claim 8, further comprising:
registering at least one of the data contributors or the at least one subscriber, wherein the registering includes receiving information to indicate a type of the raw provider data to the contributed, or a type of the formatted data to be published.

23. The method of claim 8, wherein the filtering further comprises:
filtering based on a role associated with at least one of the data contributors.

24. The method of claim 8, further comprising:
publishing an incentive structure to the data contributors.

25. The method of claim 8, wherein the publishing comprises:
publishing the formatted data to the at least one subscriber according to a timed publication schedule.

26. The method of claim 8, further comprising:
providing query services for a specified market and a product or service.
